(19) United States
(12) Patent Application Publication
(10) Pub. No.: US 2016/0375630 A1
(43) Pub. Date: Dec. 29, 2016

(54) Method For Welding Together Two Components Made Of A Thermoplastic Layer Composite Material

(71) Applicant: Airbus Operations GmbH, Hamburg (DE)

(72) Inventors: Norbert Heltsch, Hamburg (DE); Peter Linde, Hamburg (DE)

(73) Assignee: Airbus Operations GmbH, Hamburg (DE)

(21) Appl. No.: 15/190,339

(22) Filed: Jun. 23, 2016

(30) Foreign Application Priority Data
Jun. 24, 2015 (DE) 10 2015 110 193.9

(51) Int. Cl. B29C 65/08; B29C 65/16

(52) U.S. Cl. CPC B29C 65/08; B29C 65/16; B29L 2031/3076

(57) ABSTRACT

A method for welding together a first and a second multiple layered thermoplastic layer composite material component, includes removing material of the first and second components along a first and a second longitudinal edge, respectively, by a laser beam to form a first and a second step structure, respectively, having a plurality of steps. Each step is formed by one other or several others of the layers of the first and the second component, respectively, and has a surface section parallel to the direction of extension of the layers and a front section transverse to the direction of extension of the layers. The first and the second components are disposed in the abutting position, and then the first and second components are welded together by welding together the abutting surface sections of the steps of the first and second step structures.

### FIELD OF THE INVENTION

The present invention relates to a method for welding together a first component made of a thermoplastic layer or laminate composite material having several layers and a second component made of a thermoplastic layer or laminate composite material having several layers.

### BACKGROUND OF THE INVENTION

In order to connect components made of layer composite materials, such as structural components of aircraft, for example, various prior art methods are known, including, in particular, rivet connections, adhesive connections and welded connections. Rivet connections are relatively expensive and complex to implement, and the rivets used increase the overall weight. In addition, special care must always be paid to ensure that no stress concentrations develop in the vicinity of the bore holes for the rivets. Adhesive connections are also expensive and complex, as they require a special preparation of the surfaces to be bonded together. Welded connections or joints using a lap joint can be easily and reliably implemented. However, this results in a relatively large step in the conjoined surface of the connected components, and the welded connection is between only the two outer layers of the components which face one another.

### BRIEF SUMMARY OF THE INVENTION

An aspect of the present invention is to specify a method for welding together two components made of a thermoplastic laminate or layer composite material, which can be carried out easily, quickly and inexpensively, but which nevertheless results in a connection having a high level of strength.

To weld together a first component made of a thermoplastic layer or laminate composite material having several layers disposed one above the other and a second component made of a thermoplastic layer or laminate composite material having several layers disposed one above the other, the present invention envisages firstly forming a step or stepped structure on each of the components. For this purpose, material of the layer composite material of the first component is removed along a first longitudinal edge or in a first end section of the first component by means of a laser beam in order to form a first step structure having a plurality of steps at the first longitudinal edge or in the first end section. In addition, material of the layer composite material of the second component is removed along a second longitudinal edge or in a second end section of the second component by means of a laser beam in order to form a second step structure having a plurality of steps at the second longitudinal edge or in the second end section. The removal can, in each case, take place by means of, e.g., laser evaporation or laser ablation, and the laser beams can be generated for both components by the same laser device or by different laser devices. The longitudinal edges are in the usual manner edges, borders or rims of the components, which extend transversely and, preferably, perpendicularly to the stacking direction of the layers or to the direction defined by the stacking sequence of the layer composite material. The end sections are end sections in the direction of extension of the layers.

Each step of the first step structure is formed by one other or several others of the layers of the layer composite material of the first component and, more specifically, by an end section of the layer or layers. In other words, each step corresponds to one or more of the layers, and each layer is associated with only exactly one of the steps. In addition, each step has, in the usual manner, a surface section parallel to the direction of extension of the layers and a front section transverse to the direction of extension of the layers and, in particular, in their thickness direction. The layers each have two opposite—and, e.g., in particular parallel—extended surfaces, which define the direction of extension of the layers and which are connected by means of one or more surfaces, which extend transversely and, preferably, perpendicularly thereto. The thickness direction of the layers extends transversely and, preferably, perpendicularly to the extended surfaces. The surface section of each step is formed by a section of one of the extended surfaces of one of the layers. In the case of a stair step the surface section is referred to as tread, and the front section defines the rise.

In the same way, each step of the second step structure is formed by one other or several others of the layers of the layer composite material of the second component and, more specifically, by an end section of the layer or layers. In other words, each step corresponds to one or more of the layers, and each layer is associated with only exactly one of the steps. In addition, each step has, in the usual manner, a surface section parallel to the direction of extension of the layers and a front section transverse to the direction of extension of the layers. In the case of a stair step the surface section is referred to as tread, and the front section defines the rise.

The two step structures are formed in such a way that the first component and the second component can be disposed in a position in which they abut one another with their step structures, in which position the surface section of each step of the first step structure abuts a surface section of a step of the second step structure, or the surface section of each step of a consecutive subset of the steps of the first step structure in each case abuts a surface section of a step of the second step structure. In other words, with respect to each corresponding step of the first step structure, there is a lap joint with another step of the second step structure.

The first and the second components are disposed in the abutting position in this manner, and they are then welded to one another by welding together the respective abutting surface sections of the steps of the first and second step structures.

This method can be carried out easily, quickly and inexpensively, yet it increases the strength of the connection because a plurality of welded connections or joints are created between multiple layers of the two components. Furthermore, as compared to a lap joint of two complete layer composite material components, only a smaller step is created in the combined or conjoined surface of the connected components, or a step can even be completely avoided, so that, in the case of aircraft, an improvement in the aerodynamic properties can be achieved. The method can also be carried out in a simple manner automatically by means of robots.

In a preferred embodiment, the first step structure and/or the second step structure are formed in such a way that each step of the respective step structure is formed by exactly one other of the layers of the respective component. In other words, one step is formed per layer. In this manner, a particularly high number of welded connections or joints between different layers of the two components is made possible, and each layer of the first component is connected or joined to another layer of the second component. This makes it possible to achieve a particularly high strength of the connection between the two components.

It is particularly preferred if the first component and the second component have the same number of layers. In this regard, it is particularly preferred if the layers also have the same thickness and, in particular, if the layer construction or the layer structure is overall identical.

In this embodiment, the first and the second step structure can, in particular, advantageously be formed in such a way, and the abutting position can be chosen such that, in the abutting position, each layer of the first component lies at the same level as another layer of the second component. When the series or sequence of steps of the step structures of the two components in the abutting position is viewed in the same direction, the surface section of each step of the first step structure, with the exception of the first or last step, abuts a respective surface section of a corresponding step of the second step structure, and the surface section of each step of the second step structure, with the exception of the last and first step, respectively, abuts a respective surface section of a corresponding step of the first step structure. It is particularly preferred that each step is formed by exactly one other layer and/or that the front section of each step of the first step structure abuts a front section of a step of the second step structure. In any case, steps in the combined or conjoined surface of the connected components can be minimized in their height or completely avoided.

Alternatively, in this embodiment, the first and the second step structure can advantageously be formed in such a way, and the abutting position can be chosen such that, in the abutting position, the first component and the second component are disposed offset to one another by one layer. In other words, the surface section of each step of the first step structure abuts a surface section of a corresponding step of the second step structure, and vice versa. It is particularly preferred that each step is formed by exactly one other layer and/or that the front section of each step of the first step structure abuts a front section of a step of the second step structure. In any case, the number of the welded connections or joints, with which layers of the first component are connected or joined to layers of the second component, is advantageously maximized, since all layers of the first component and of the second component are each welded to exactly one other corresponding layer of the other component. The strength of the connection between the two components can thus be maximized at the expense of a slight step in the combined or conjoined surfaces of the connected components. By contrast with the prior art, the step height or rise amounts only to the thickness of one layer.

In a preferred embodiment of the method, the first and the second step structures are formed in such a way that, in the abutting position, the front section of one, several or all of the steps of the first step structure abuts a front section of a step of the second step structure, i.e., such that the corresponding layers are each disposed in a butted or butt joint.

In a preferred embodiment, following the formation of the first step structure and the second step structure, the surface sections of the steps of the first step structure and of the second step structure are machined or processed in order to reduce the surface roughness. This can take place, for example, using the same laser used to form the step structures, or with another laser. By means of such a surface treatment or finishing the strength and reliability of the individual welded connections can be increased.

The welding can advantageously take place by means of laser welding, ultrasonic welding, induction welding and/or resistance welding. If laser welding is used, the energy, the wavelength and the focusing of the laser beam are each selected such that the laser beam partially passes through the layer series or sequence of layers and the energy required for the welding in the respective welding zone is concentrated or deposited at the boundary surface between two surface sections of two steps.

In a preferred embodiment of the method, the first component and the second component are brought into the abutting position with the aid of a support device. For this purpose, the first component and the second component are positioned or laid spaced apart from one another on the support device in such a way that the first step structure and the second step structure face one another. The first component and the second component are then moved towards one another. It is possible in this regard that only the first component, only the second component or both components are moved. The support device is designed and adapted such that it guides the first component and the second component into the abutting position when the two components are moved towards one another. For this purpose, the support device can, in particular, have a suitably shaped support surface, which is adapted to the shape of the two components, so that they are disposed in predetermined positions on the support surface and then must only be moved towards one another in order to bring them into the abutting position.

In an advantageous embodiment, the first component and the second component are each structural components of an aircraft, such as, for example, fuselage components or fuselage sections which must be connected to one another in order to form an aircraft fuselage.

### BRIEF DESCRIPTION OF THE DRAWINGS

An exemplary embodiment of the invention is explained in greater detail below with reference to the attached figures.

FIG. 1a shows two plate-shaped components made of a thermoplastic layer composite material, which are disposed spaced apart from one another.

FIG. 1b shows the two plate-shaped components of FIG. 1a after completion of a laser evaporation step for the formation of step structures at the longitudinal edges or end sections of the two components which face one another.

FIG. 1c shows the two plate-shaped components of FIG. 1b, after they have been brought into abutment.

FIG. 1d shows the two abutting plate-shaped components of FIG. 1c, after they have been welded together.

FIG. 2a shows the two plate-shaped components of FIG. 1b, after they have been brought into abutment in a different manner than in FIG. 1c.

FIG. 2b shows the two abutting plate-shaped components of FIG. 2a, after they have been welded together.

FIG. 3a shows two plate-shaped components made of a thermoplastic layer composite material, which are disposed on a transport and processing trolley.

FIG. 3b shows the two plate-shaped components of FIG. 3b during a laser evaporation step for the formation of step structures along a respective longitudinal edge or in a respective end section of the two components.

FIG. 3c shows the two plate-shaped components of FIG. 3b after arrangement on a support device.

FIG. 3d shows the two plate-shaped components of FIG. 3c, after they have been brought into abutment on the support device and during a laser welding step.

FIG. 4 shows a flowchart of an exemplary embodiment of a method according to the invention for welding together two components made of a thermoplastic layer composite material.

### DETAILED DESCRIPTION

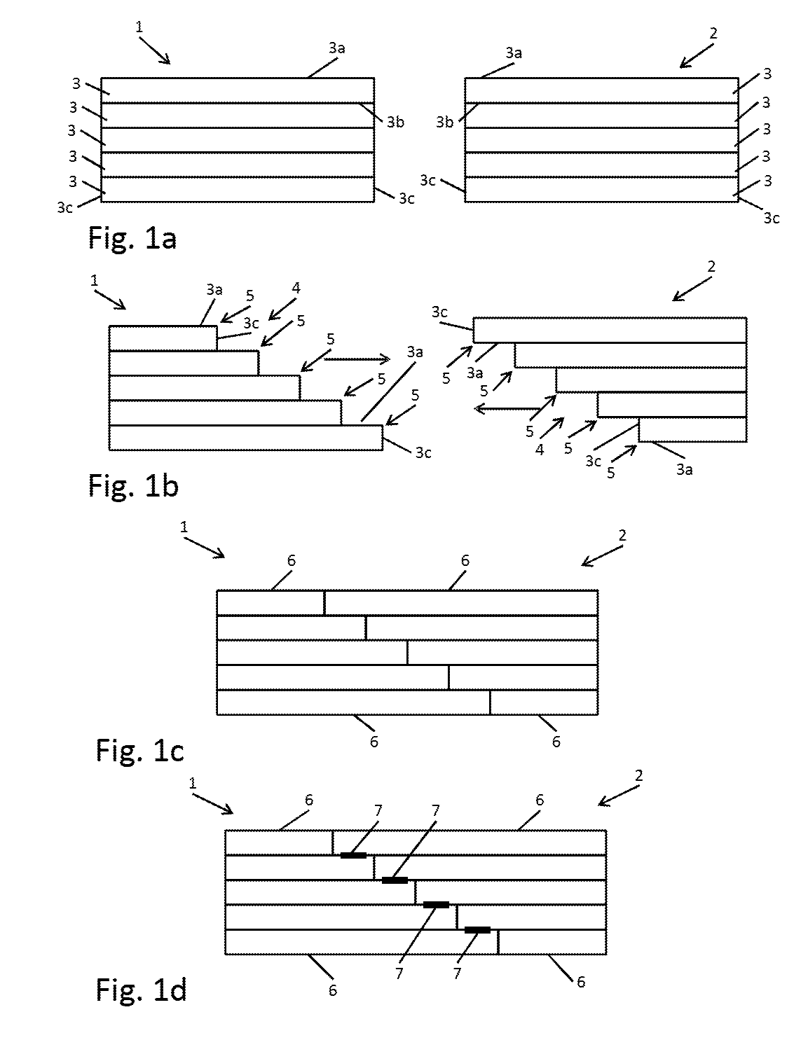

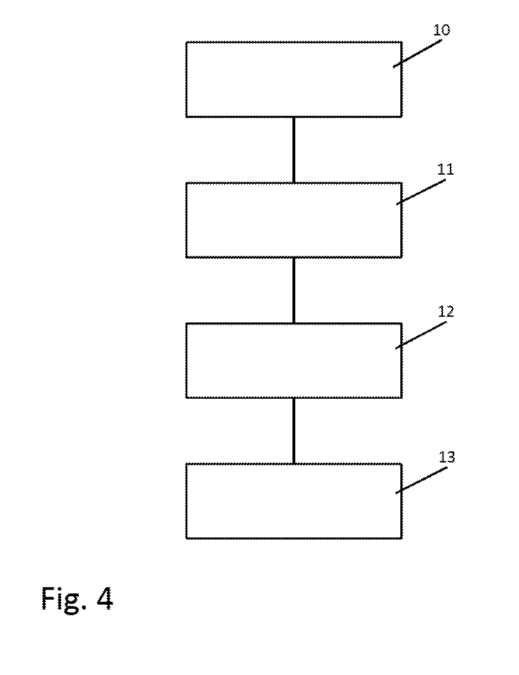

In FIGS. 1a to 1d it is schematically illustrated how a first component 1 and a second component 2, which are each made of a thermoplastic layer or laminate composite material having multiple layers, are welded together. In the depicted exemplary embodiment, the two components 1, 2 are fuselage sections of an aircraft fuselage. The corresponding method is illustrated in FIG. 4.

As shown in FIG. 1a, the two components 1, 2 are plate-shaped and comprise a plurality of layers 3 (five in the example depicted), which are disposed one on top of the other. The layers 3 are provided in the same number and with the same thickness in each component 1, 2. Each layer has two opposite extended surfaces 3a, 3b, between which lateral or side surfaces 3c extend (depicted for only one layer 3 in each case). In the depicted example, the layers 3 are dimensioned such that the lateral surfaces 3c of the layers of each component 1, 2 are aligned with one another and form straight lateral or side surfaces of the components 1, 2. Each layer 3 is made of a thermoplastic material into which, for the purpose of reinforcement, fibers may be embedded, such as, for example, glass fibers and/or carbon fibers (not depicted).

The two components 1, 2 are each subjected to a laser ablation or evaporation step, in which material is removed by means of a laser beam in order to form, on a longitudinal edge of each component 1, 2 or at an end section of each component 1, 2, a step structure 4 having multiple steps 5. In this regard, each step 5 is preferably formed by an end section of exactly one other of the layers 3 so that, in the depicted example, five steps are created per component 1, 2. Each step 3 of the component 1 is formed by a surface section of the extended surface 3a of the corresponding layer 3 and a lateral surface 3c of the corresponding layer 3. The surface section of the extended surface 3a defines the tread, and the lateral surface 3c defines the rise or height of the step 3. Each step 3 of the component 2 is formed by a surface section of the extended surface 3b of the corresponding layer 3 and a lateral surface 3c of the corresponding layer 3. The surface section of the extended surface 3b defines the tread, and the lateral surface 3c defines the rise or height of the step 3.

As can be seen from FIGS. 1b and 1c, the two step structures 4 complement one another, or are complementary with respect to each other, so that they can be brought into mating engagement with one another. For this purpose, the two components 1, 2 are disposed before or after the laser evaporation or ablation step in such a way that the formed step structures 4 or the corresponding longitudinal edges or end sections face one another and are disposed at the same level or height. The two components 1, 2 are then moved towards one another, as indicated by the arrows in FIG. 1b, until the step structures 4 engage or mesh with one another and the components 1, 2 abut one another by means of the step structures 4. This position is shown in FIG. 1c, from which it can be seen that the two components 1, 2 are both disposed on the same level. Due to this each layer 3 of the first component 1 is associated with exactly one layer 3 of the second component 2 and is disposed at the same level or height as it. The front faces 3c of these layers 3 associated with one another abut one another in a butt joint. Due to this arrangement of the two components 1, 2, the two outer surfaces 6 of the combination or conjunction of the two components 1, 2 have no step, which ensures good aerodynamic properties.

In this abutting position, the two components 1, 2 are then welded together by means of laser welding, specifically, in each case at the abutting surface sections 3a of the steps 3. As depicted in FIG. 1d, four welded connections or joints 7 are thus produced between four pairs of steps. During laser welding, the laser beam used is in each case focused on the desired welding area, so that the layers lying above it are penetrated by the laser beam without causing damage to the material.

Due to the separate welded connection of multiple layers of the two components 1, 2, a high strength and reliability of the connection is achieved.

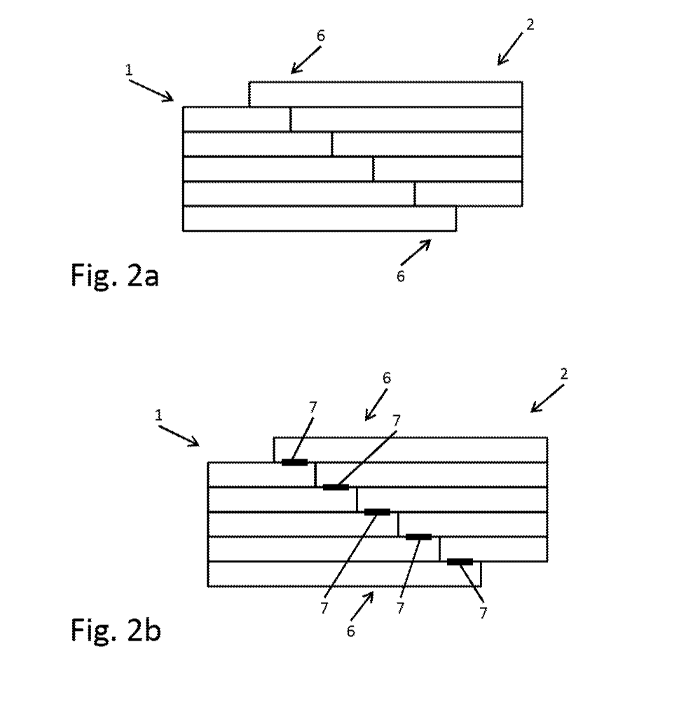

In an alternative embodiment of the method, the two components 1, 2 are, after the formation of the two step structures 4, again moved towards one another in accordance with FIG. 1b until the step structures 4 matingly engage with one another and the components 1, 2 abut one another by means of the step structures 4, but in such a way that the two components 1, 2 are disposed offset to one another by one layer. This alternative abutting position is depicted in FIG. 2a, from which it can be seen that the layer 3 of the component 1, which layer 3 is bottommost in the figure, is disposed below the bottommost layer 3 of the component 2, the uppermost layer 3 of the component 2 is disposed above the uppermost layer 3 of the component 1, and all remaining layers 3 of the two components 1, 2 are each associated with exactly one layer 3 of the other component 1, 2 and are disposed at the same level as the associated layer 3 of the other component 1, 2. The front faces 3c of these layers 3 associated with one another each abut one another in the butt joint. Due to this arrangement of the two components 1, 2, the two outer surfaces 6 of the combination or conjunction of the two components 1, 2 each have a step, which is, however, only a layer thickness in height.

In this alternative abutting position, the two components 1, 2, just like in the case of FIG. ld, are then welded together by means of laser welding, and specifically in each case on the abutting surface sections 3a of the steps 3. As shown in FIG. 2b, five welded connections 7 are thus produced between all five pairs of steps. The slightly reduced aerodynamic properties compared with the example of FIG. 1d, thus go hand in hand with an even greater strength and reliability of the connection, because separate welded connections or joints now exist for all layers 3 of the two components 1, 2.

In general, the method for connecting or joining the two components 1, 2 in accordance with the two exemplary embodiments thus comprises, as depicted in FIG. 4, the step 10 of laser evaporation or ablation for the formation of the step structure 4 of the first component 1, the step 11 of laser evaporation or ablation for the formation of the step structure 4 of the second component 2, the step 12 of arranging the first component 1 and the second component 2 in the abutting position, as is shown, for example, in FIGS. 1c and 2a, and the step 13 of welding together the first component 1 and the second component 2, by welding together the abutting surface sections 3a of the steps 3 of the first and second step structures 4.

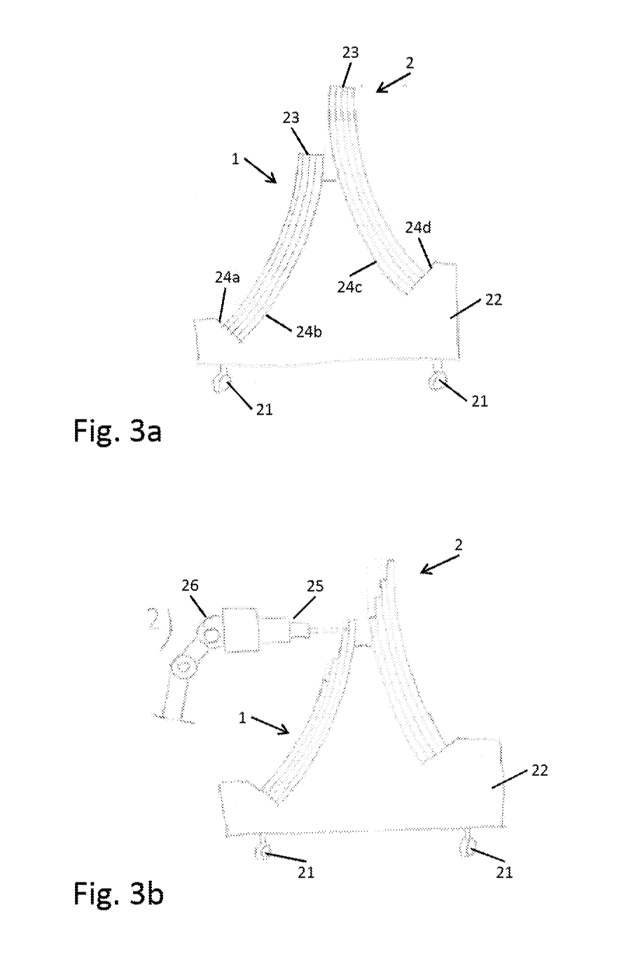

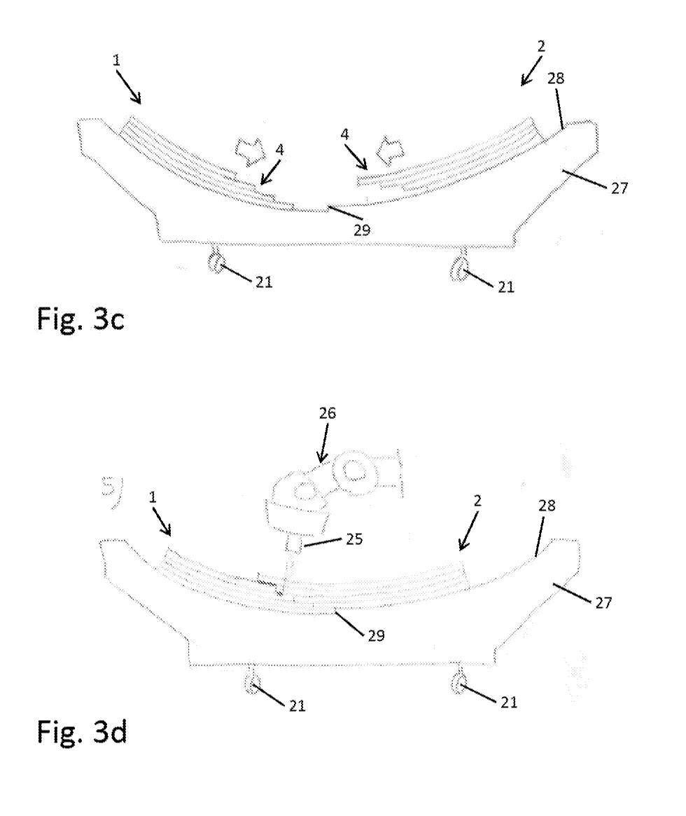

FIGS. 3a to 3d depict an advantageous possibility of how the above method steps may be carried out, which are generally and schematically illustrated in FIGS. 1a to 2d.

The two components 1, 2, which are shown in FIGS. 3a to 3d as curved plate-shaped fuselage segments, are disposed and supported in such a way on a first support device 22 provided with castors 21 that their longitudinal edges or end sections 23, at which the step structures 4 are to be formed, face upwards and are therefore freely accessible for a laser evaporation or ablation. For this purpose, the first support device 22 comprises support surfaces 24a, 24b, 24c and 24d, which are adapted to the shape of the components 1, 2.

With the aid of the castors 21, the first support device 22 can be moved to a laser device 25 which is mounted on a robot arm 26. This allows the step structures 4 to be automatically produced on the two longitudinal edges or end sections 23 by means of laser evaporation or ablation controlled by a control device. For this purpose, the control device stores information about the dimensions and the layer construction of the two components 1, 2, which are taken into account when controlling the robot arm 26 and the laser device 25.

The two components 1, 2 are then disposed spaced apart from one another on a second support device 27 provided with castors 21 and are supported on the second support device 27, which support device has a curved support surface 28, the curvature of which corresponds to the curvature of the two components 1, 2 (see FIG. 3c). The positioning is effected such that the two step structures 4 face one another, and specifically in such a way that, simply by moving the two components 1, 2 towards one another (see the arrows in FIG. 3c), they can be pushed into one another and then abut one another in the manner described above and depicted in FIG. 2a. For this purpose, a step 29 is provided in the support surface 28, which is as high as a layer thickness of the layers 3 and which ensures an arrangement of the two components 1, 2 offset by the thickness of one layer. The support surface 28 easily guides the two components 1, 2 into the position shown in FIGS. 2a and 3d.

Finally, the support device 27 is once again moved with the aid of the castors 21 to the laser device 25 mounted on the robot arm 26 and is welded by it in the manner depicted in FIG. 2b.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for welding together a first component made of a thermoplastic layer composite material having multiple layers and a second component made of a thermoplastic layer composite material having multiple layers comprising:
removing material of the layer composite material of the first component along a first longitudinal edge of the first component by a laser beam to form a first step structure having a plurality of steps on the first longitudinal edge, with each step of the first step structure being formed by one other or several others of the layers of the layer composite material of the first component, and having a surface section parallel to the direction of extension of the layers and a front section transverse to the direction of extension of the layers,
removing material of the layer composite material of the second component along a second longitudinal edge of the second component by a laser beam to form a second step structure having a plurality of steps on the second longitudinal edge, wherein
each step of the second step structure is formed by one other or several others of the layers of the layer composite material of the second component, and has a surface section parallel to the direction of extension of the layers and a front section transverse to the direction of extension of the layers, and
the first component and the second component are configured to be disposed with their step structures in an abutting position, in which position the surface section of each step of the first step structure or a consecutive subset of the steps of the first step structure in each case abuts a surface section of a step of the second step structure,
arranging the first component and the second component in the abutting position, and
subsequently welding together the first component and the second component, by welding together the abutting surface sections of the steps of the first and second step structures.

2. The method according to claim 1, wherein the first and/or the second step structures are formed in such a way that each step is formed by exactly one other of the layers of the respective step structure.

3. The method according to claim 1, wherein the first component and the second component comprise the same number of layers.

4. The method according to claim 3, wherein the first and the second step structures are formed in such a way and the abutting position is chosen such that, in the abutting position, each layer of the first component lies at the same level as another layer of the second component.

5. The method according to claim 3, wherein the first and the second step structures are formed in such a way and the abutting position is chosen such that, in the abutting position, the two components are disposed offset to one another by one layer.

6. The method according to claim 1, wherein the first and the second step structures are formed in such a way that, in the abutting position, the front section of at least a portion of the steps of the first step structure abuts a front section of a step of the second step structure.

7. The method according to claim 1, wherein, after the formation of the first step structure and the second step structure, the surface sections of the steps of the first step structure and the second step structure are processed to reduce the surface roughness.

8. The method according to claim 1, wherein the welding takes place by laser welding, ultrasonic welding, induction welding and/or resistance welding.

9. The method according to claim 1, wherein the first component and the second component are brought into the abutting position by
laying the first component and the second component spaced apart from one another on a support device in such a way that the first step structure and the second step structure face one another, and
then moving the first component and the second component towards one another, wherein the support device is constructed such that the support device guides the first component and the second component into the abutting position.

10. The method according to claim 1, wherein the first component and the second component are each structural components of an aircraft.
